(19) United States
(12) Patent Application Publication
(10) Pub. No.: US 2013/0213004 A1
(43) Pub. Date: Aug. 22, 2013

(54) MULTI-ELECTRODE IGNITER FOR A GAS TURBINE ENGINE

(71) Applicants: Shervin Rodd, Chuluota, FL (US); Ryan Kelbey, Belton, SC (US); Adam M. Foust, Orlando, FL (US); Jim Causey, Greenville, SC (US)

(72) Inventors: Shervin Rodd, Chuluota, FL (US); Ryan Kelbey, Belton, SC (US); Adam M. Foust, Orlando, FL (US); Jim Causey, Greenville, SC (US)

(21) Appl. No.: 13/402,436

(22) Filed: Feb. 22, 2012

(51) Int. Cl. F02C 7/266

(52) U.S. Cl. 60/39.827

(57) ABSTRACT

An ignition system for a combustor of a gas turbine engine is disclosed. The ignition system may include multiple igniters to reduce the likelihood of system failure. In at least one embodiment, the ignition system may be formed from a first igniter formed from an outer electrode containing at least one central electrode at a distal end of the outer electrode and may include a second igniter. The second igniter may be formed from a central electrode positioned within the outer electrode forming the first igniter. During operation, the igniters may spark to ignite the fuel mixture within the combustor.

### FIELD OF THE INVENTION

This invention is directed generally to gas turbine engines, and more particularly to ignition systems in gas turbine engines.

### BACKGROUND

Typically, gas turbine engines include a compressor for compressing air, a combustor for mixing the compressed air with fuel and igniting the mixture, and a turbine blade assembly for producing power. Combustors are typically formed from a plurality of combustor baskets positioned concentrically about the longitudinal axis of a gas turbine engine. Combustion systems with cross flame tubes typically have two baskets with igniters while combustion systems without cross flame tubes contain a single igniter having a single electrode for igniting the fuel mixture within each combustor basket.

### SUMMARY OF THE INVENTION

This invention relates to an ignition system for a combustor of a gas turbine engine. The ignition system may include igniters with multiple electrodes to reduce the likelihood of system failure. In at least one embodiment, the ignition system may be formed from a first igniter formed from an outer electrode containing at least one central electrode at a distal end of the outer electrode and may include a second igniter. The second igniter may be formed from a central electrode positioned within the outer electrode forming the first igniter. During operation, both electrodes of the igniters may spark to ignite the fuel mixture within the combustor.

The ignition system for a gas turbine engine may include a first igniter formed from an outer electrode containing at least one central electrode at a distal end of the outer electrode, a second igniter formed from at least one central electrode and at least one outer electrode. The central electrode of the second igniter may be positioned within the outer electrode of the first igniter at the distal end of the outer electrode. A cable connection may be positioned at a proximal end of the outer electrode of the first igniter to couple the igniter to other turbine components, such as a control system. A first exciter may be in electrical communication with the first igniter, and a second exciter may be in electrical communication with the second igniter. In another embodiment, the first exciter may be in electrical communication with the first igniter and the second igniter. In one embodiment, the central electrodes of the first and second igniters may be contained within the same outer electrode.

An advantage of this invention is that the ignition system includes redundancy, thereby reducing the likelihood of system failure should one of the igniters fail.

Another advantage of this invention is that the ignition system includes redundancy while using the existing penetrations in the basket.

These and other embodiments are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a partial cross-sectional side view of a portion of a turbine engine including the ignition system.

FIG. 2 is a partial perspective end view of an igniter.

FIG. 3 is a cross-sectional side view of the ignition system positioned in a wall forming a combustor.

FIG. 4 is a partial perspective end view of an igniter having dual electrodes.

### DETAILED DESCRIPTION OF THE INVENTION

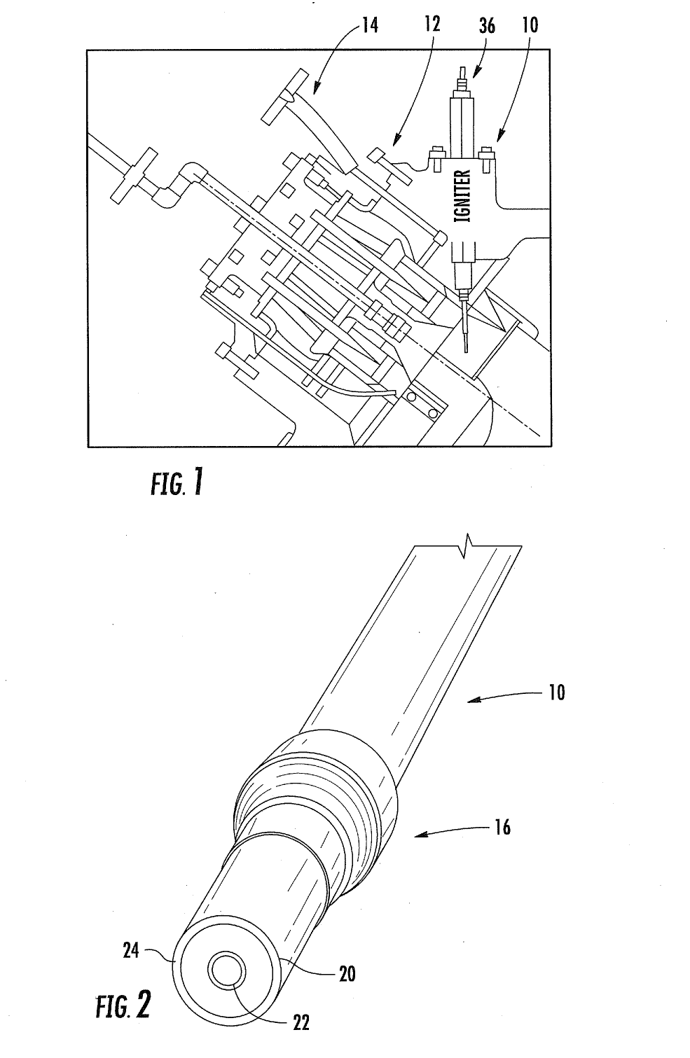

As shown in FIGS. 1-4, this invention is directed to an ignition system 10 for a combustor 12 of a gas turbine engine 14. The ignition system 10 may include igniters 16 with multiple electrodes 22 to reduce the likelihood of system failure. In at least one embodiment, the ignition system 10 may be formed from a first igniter 18 formed from an outer electrode 20 containing at least one central electrode 22 at a distal end 24 of the outer electrode 20 and may include a second igniter 26. The second igniter 26 may be formed from a central electrode 28 positioned within the outer electrode 20 forming the first igniter 18. During operation, both electrodes of the igniters 16 may spark to ignite the fuel mixture within the combustor 12.

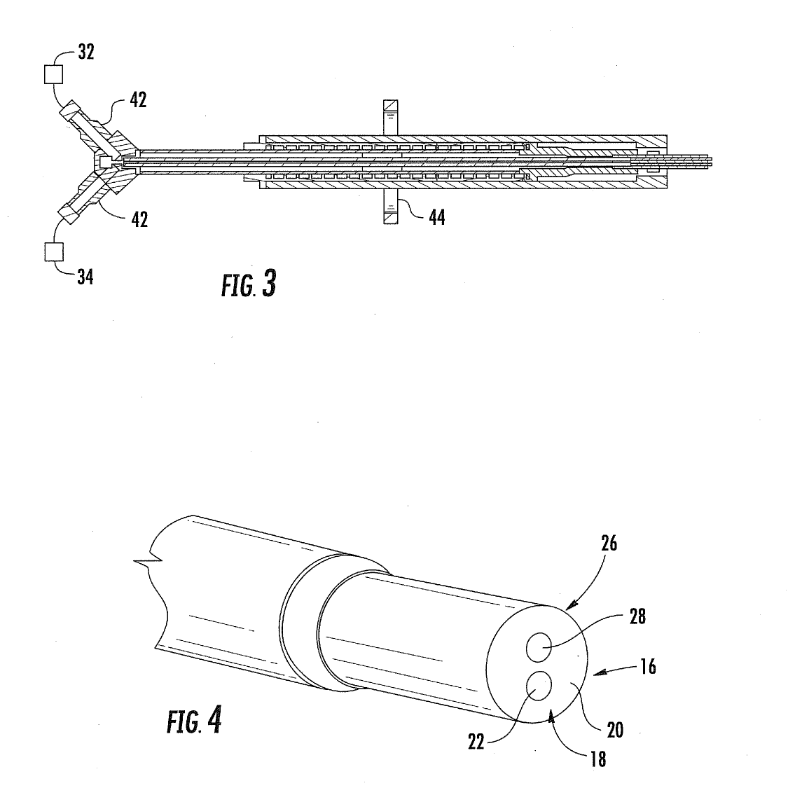

A shown in FIGS. 3-4, the ignition system 10 for a gas turbine engine 14 may be formed from a first igniter 18 formed from an outer electrode 20 containing at least one central electrode 22 at a distal end 24 of the outer electrode 20. The outer electrode 20 may be formed from any appropriate configuration. In at least one embodiment, the outer electrode 20 may be, but is not limited to being, generally cylindrical, such as a tube formed from materials capable of withstanding temperatures of burning fuel mixtures. The outer electrode 20 may be fastened to a stationary component of the gas turbine engine such that the distal end 24 is positioned within the combustor 12. The outer electrode 20 may have any appropriate length that positions the distal end 24 of the igniter 18 in an appropriate location within the combustor 12. The outer electrode 20 may be positioned radially outward from the central electrode 22. In at least one embodiment, the outer electrode 20 may be concentric with the central electrode 22. In another embodiment, the central electrode 22 may be positioned within the outer electrode 20 but is not concentric with the outer electrode 20.

The ignition system 10 may include a second igniter 26 formed from at least one central electrode 28. As shown in FIG. 4, the central electrode 28 of the second igniter 26 may be positioned within the outer electrode 20 at the distal end 24 of the outer electrode 20. As such, the central electrode 22 for the first igniter 18 and the central electrode 28 for the second igniter 26 is contained within the outer electrode 20. The central electrodes 22, 28 contained within the outer electrode 20 may be coupled to a single exciter 32 or may be coupled to two or more exciters 32, 34.

The first igniter 18 may include a cable connection 42 for attaching the first igniter 18 to an exciter 32 or other appropriate components. The cable connection 42 may be, but is not limited to being, a releasable connector such as a threaded connector, a quick connect connector or the like. The cable connection 42 may be positioned at a proximal end of the outer electrode of the first igniter 18.

In one embodiment, a first exciter 32 may be in electrical communication with the first igniter 18, and a second exciter 34 may be in electrical communication with the second igniter 26. As such, if one of the exciters 32, or 34 malfunctions, the ignition system 10 is still able to function using the remaining, operable exciter 32, or 34 to ignite the fuel mixture within the combustor 12. In another embodiment, the first exciter 32 may be in communication with the first and second igniters 18, 26.

The gas turbine engine 14 in which the ignition system 10 is contained may include one or more combustors 14. The combustor 14 may be formed form one or more combustor baskets 36. The combustor baskets 36 may have any appropriate configuration. The ignition system 10 may be used together with one or more combustor baskets 36 within a gas turbine engine 14.

As shown in FIG. 3, the ignition system 10 may be releasably coupled to a component 44 of a gas turbine engine 14 such that the distal end 24 of the outer electrode 20 is positioned as desired within the combustor 12. In at least one embodiment, the outer electrode 20, may be attached to an igniter assembly that includes threads to threadably attach the igniter assembly to the gas turbine engine 14. The first and second igniters 18, 26 may be coupled to one or more exciters 32, 34 that are, in turn, in electrical communication with one or more control systems. The control system controls the firing of the ignition system 10 to control the firing of the first and second igniters 18, 26 within the combustor 12. The first and second igniters 18, 26 reduce the likelihood of system failure by adding redundancy to the system 10. Should one of the igniters 18, 26 fail, the other igniter 18, 26 is able to continue operating without fail. In addition, should one of the exciters fail 32, 34, the other exciter 32, 34 is able to continue operation without necessitating shut down of the gas turbine engine 14.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. An ignition system for a gas turbine engine, comprising:
a first igniter formed from an outer electrode containing at least one central electrode at a distal end of the outer electrode; and
a second igniter formed from at least one central electrode and the outer electrode.

2. The ignition system of claim 1, wherein the at least one central electrode of the second igniter is positioned within the outer electrode of the first igniter at the distal end of the outer electrode.

3. The ignition system of claim 1, further comprising a cable connection positioned at a proximal end of the outer electrode of the first igniter.

4. The ignition system of claim 1, further comprising a first exciter in electrical communication with the first igniter and a second exciter in electrical communication with the second igniter.

5. The ignition system of claim 1, further comprising a first exciter in electrical communication with the first igniter and the second igniter.

6. A combustor for a gas turbine engine, comprising:
at least one combustor basket;
at least one ignition system comprising:
a first igniter formed from an outer electrode containing at least one central electrode at a distal end of the outer electrode; and
a second igniter formed from at least one central electrode and the outer electrode.

7. The combustor of claim 6, wherein the at least one central electrode of the second igniter is positioned within the outer electrode of the first igniter at the distal end of the outer electrode.

8. The combustor of claim 6, further comprising a cable connection positioned at a proximal end of the outer electrode of the first igniter.

9. The combustor of claim 6, further comprising a first exciter in electrical communication with the first igniter and a second exciter in electrical communication with the second igniter.

10. The combustor of claim 6, further comprising a first exciter in electrical communication with the first igniter and the second igniter.

11. An ignition system for a gas turbine engine, comprising:
a first igniter formed from an outer electrode containing at least one central electrode at a distal end of the outer electrode;
a second igniter formed from at least one central electrode and the outer electrode;
a cable connection positioned at a proximal end of the outer electrode of the first igniter; and
at least one exciter in electrical communication with the first igniter and the second igniter.

12. The ignition system of claim 11, wherein the at least one central electrode of the second igniter is positioned within the outer electrode of the first igniter at the distal end of the outer electrode.
